(19) United States
(12) Patent Application Publication
(10) Pub. No.: US 2023/0189405 A1
(43) Pub. Date: Jun. 15, 2023

(54) Induction Cooktop and Method for Controlling an Induction Cooktop

(71) Applicant: SABAF S.P.A., Ospitaletto (IT)

(72) Inventors: Cristiano Pastore, Ospitaletto (IT); Salvatore Restivo, Ospitaletto (IT)

(73) Assignee: SABAF S.P.A., Ospitaletto (IT)

(21) Appl. No.: 18/077,704

(22) Filed: Dec. 8, 2022

(30) Foreign Application Priority Data
Dec. 10, 2021 (IT) 21213885.3

(51) Int. Cl. H05B 6/06; H05B 6/12; H02M 3/156

(52) U.S. Cl. CPC H05B 6/062; H05B 6/1236; H02M 3/156

(57) ABSTRACT

An induction cooktop includes: a first induction heater and a second induction heater; a control unit; a first switching current generator and a second switching current generator, operable by the control unit in subsequent control periods to energize the first induction heater and the second induction heater, respectively. The control unit configured to: operate both the first switching current generator and the second switching current generator with a first switching frequency in a first control interval of each control period; operate only the first switching current generator with at least two respective different switching frequencies in a second control interval and in a third control interval of each control period, while the second switching current generator is inactive; operate only the second switching current generator with at least two respective different switching frequencies in a fourth control interval and in a fifth control interval of each control period, while the first switching current generator is inactive.

### CROSS-REFERENCE TO RELATED APPLICATIONS

This patent application claims priority from European patent application no. 21213885.3 filed on Dec. 10, 2021, the entire disclosure of which is incorporated herein by reference.

### TECHNICAL FIELD

The present invention relates to an induction cooktop and method for controlling an induction cooktop.

### BACKGROUND

As it is known, an induction cooktop may comprise at least one pair of high frequency current generators, sharing common mains line, rectifier and DC link and configured to energize respective induction heaters (also referred to as “pancake coils”). One major issue involved in driving induction cooktops operated with individual inverters resides in determining the power vs. switching frequency (or switching period) characteristics when the induction heaters are coupled to specific cooking vessels. These characteristics, in fact, form the basis for independent control of the high frequency current generators that meets user's demand of power and, at the same time, avoids audible noise caused by frequency intermodulation which normally occur when two high frequency current generators are operated at different frequencies.

The power vs. switching frequency or period characteristics, which will be hereinafter generally referred to as power characteristics for the sake of simplicity, obviously need to be determined at the start of a cooking process for each induction heaters in use. According to known solutions, described e.g. in EP 1 951 003 A1 and in EP 2 200 398 A1, the power characteristics may be preliminarily determined by measuring or estimating power delivered to the cookware during a frequency scan through a plurality of discrete frequency steps.

However, several variable external factors heavily affect the power characteristics during the cooking process and the initial estimation requires to be quite frequently updated. Factors that have influence on power transfer and heating include, for example, cookware temperature, cookware position with respect to the induction heaters, mains voltage and coil temperature. In known control devices, deviations from the currently used power characteristics are monitored and a new frequency scan is carried out every time refresh or new acquisition is required. The problem of changes in power characteristics is thus mitigated, but limitations still remain. Mainly, each frequency scan disrupts power delivery and interruptions in the control sequence may cause power fluctuations and possibly increase of flicker emissions. On the other hand, the power characteristics cannot be updated once the control sequence has been started unless a new frequency scan is performed.

As a result, refresh of the power characteristics is not as frequent as it would be desirable and power delivery is impaired.

### SUMMARY OF THE INVENTION

It is an aim of the present invention to provide an induction cooktop and a method for controlling an induction cooktop that allow the above limitations to be overcome or at least reduced.

According to the present invention there are provided an induction cooktop and a method of controlling an induction cooktop as defined in claims 1 and 10, respectively.

### BRIEF DESCRIPTION OF THE DRAWINGS

The present invention will now be described with reference to the accompanying drawings, which show a number of non-limitative embodiments thereof, in which:

FIG. 1 is a simplified block diagram of an induction cooktop in accordance with an embodiment of the present invention;

FIG. 2 is a circuit diagram of components of the induction cooktop of FIG. 1;

FIG. 3 is a graph showing quantities in a control period of the induction cooktop of FIG. 1;

FIG. 4 is a graph showing power characteristics of the induction cooktop of FIG. 1; and.

FIG. 5 is a circuit diagram of components of an induction cooktop in accordance with another embodiment of the present invention.

### DESCRIPTION OF EMBODIMENTS

With reference to FIG. 1, an induction cooktop is designated as a whole by number 1 and comprises a glass-ceramic plate 2, at least a pair of induction heaters including a first induction heater 3 and a second induction heater 4 at respective cooking zones below the plate 2, and a converter 5, configured to couple to a supply line (mains) 7 through a coupling interface 8 to receive an AC supply voltage V_{AC} and to independently energize the induction heaters 3, 4. The coupling interface 8 allows connection to the supply line 7 and may include a terminal block and EMI (Electro-Magnetic Interference) suppression filters (not shown). In embodiments not shown, an induction cooktop may include a plurality of pairs of induction heaters, each pair of induction heaters being supplied by one respective common mains phase. A user interface 9 allows users to select average power levels to be delivered to the induction heaters 3, 4.

In use, induction cooking vessels 10, 11 are arranged at the cooking zones in positions corresponding to respective induction heaters 3, 4. When the induction heaters 3, 4 are energized, Eddy currents are induced in the cooking vessels 10, 11, which are thus heated.

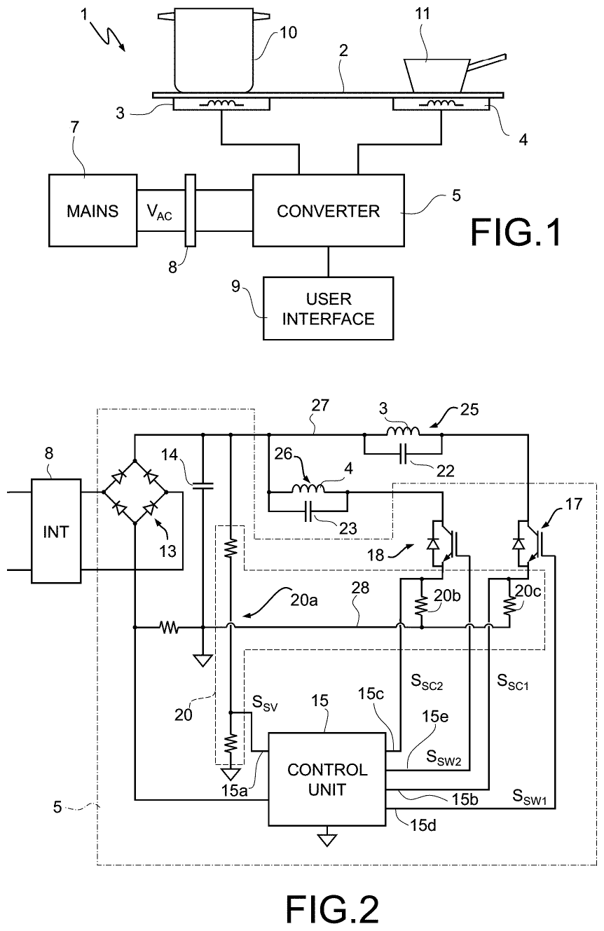

In accordance with a non-limiting embodiment of the present invention illustrated in FIG. 2, the converter 5 comprises a rectifier 13, a DC link capacitor 14, a control unit 15, a first power switch 17, a second power switch 18 and a power detector 20, that in turn includes a voltage sensing network 20a and current sensors 20b, 20c. The first induction heater 3 and the second induction heater 4 with respective resonant capacitors 22, 23 form a first resonant circuit 25 and a second resonant circuit 26, respectively driven by the first power switch 17 and the second power switch 18, which are operated as switching current generators by the control unit 15. In the embodiment of FIG. 2, the converter 5 (more specifically the control unit 15, the first power switch 17 and the second power switch 18) is in single-ended quasi resonant configuration with the first resonant circuit 25 and a second resonant circuit 26. The first power switch 17 and the second power switch 18 may be any suitable kind of device, such as IGBTs or power MOSFETs. It is also understood that the converter is not limited to the quasi resonant configuration and other configuration may be exploited as well, such as a half-bridge configuration as explained in detail later on.

The rectifier 13 and the DC link capacitor 14 supply a rectified voltage to rails 27, 28 and the control unit 15 controls the power switches 17, 18 to energize the induction heaters 3, 4 and deliver power to the cooking vessels 10, 11 in accordance with user's requests.

The power detector 20 is configured to continuously sense an active power individually delivered by each of the induction heaters 3, 4 to the cooking vessels 10, 11 and, in the non-limiting embodiment of FIG. 2, includes the voltage sensing network 20a and the current sensors 20b, 20c, as already mentioned. The voltage sensing network 20a may include a voltage divider connected between the rails 27, 28 and having an intermediate node coupled to a voltage sense input 15a of the control unit 15. The current sensors 20b, 20c may include resistors in series to conduction terminals of respective power switches 17, 18 and are coupled to respective current sense input 15b, 15c of the control unit 15. It is however understood that any suitable power detector may be used in place of the power detector 20 of FIG. 2, including power detectors with common current sensors for the power switches 17, 18. The power detector 20 supplies power sense signals, based on which the control unit 15 determines the active power delivered by the power switches 17, 18. In the non-limiting embodiment of FIG. 2, power sense signals include a voltage sense signal S_{SV} supplied by the voltage sensing network 20a and current sense signals S_{SC1}, S_{SC2} supplied the current sensors 20b, 20c, respectively.

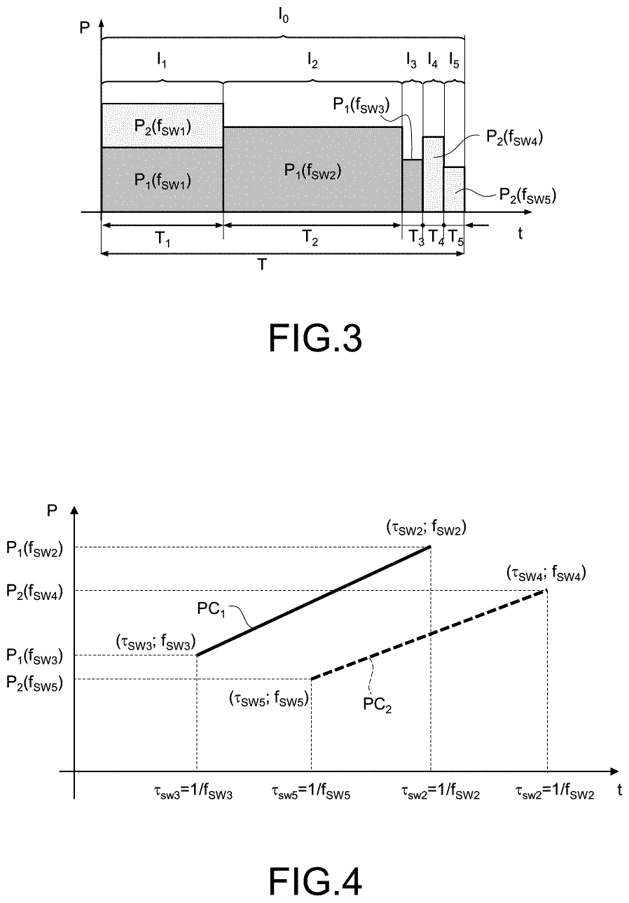

The control unit 15 has control outputs 15d, 15e coupled to control terminals of respective power switches 17, 18 and is configured to operate the power switches 17, 18 on the basis of a control procedure and of power measurements received from or based on the power sense signals S_{SV}, S_{SC1}, S_{SC2} provided by the power detector 20, so as to energize the induction heaters 3, 4 and deliver power to the cooking vessels 10, 11 in accordance with user's requests. Specifically, the power switches 17, 18 are operated on control cycles having a control period I₀ of duration T, one of which is shown in FIG. 3. Each control period I₀ includes a plurality of control intervals, in which the first power switch 17 and the second power switch 18 are operated by the control unit 15 as switching current generators at controlled switching frequencies through a first control signal S_{SW1} and a second control signal S_{SW2}, respectively. The control signals S_{SW1}, S_{SW2} are provided on the control outputs 15d, 15e of the control unit 15 and applied to the control terminals of the respective power switches 17, 18.

Specifically, in a first control interval I₁, having a first duration T₁, the control unit 15 activates both the first induction heater 3 and the second heater 4 simultaneously by operating both the first power switch 17 and the second power switch 18 with a first switching frequency f_{SW1}.

In a second control interval I₂, having a second duration T₂, the control unit 15 activates only one of the induction heaters 3, 4, which has the most demanding task in terms of power to be delivered, by operating the respective power switch. In the example of FIG. 3, the first induction heater 3 is energized by operating the first power switch 17 with a second switching frequency f_{SW2}.

In a third control interval I₃, having a third duration T₃, the control unit 15 activates only the induction heater that had been already activated during the second control interval I₂, i.e. the first induction heater 3, by operating the first power switch 17 with a third switching frequency f_{SW3}. The third switching frequency f_{SW3} is different from and preferably greater than the second switching frequency f_{SW2}.

In a fourth control interval I₄, having a fourth duration T₄, only the induction heater that was inactive in the second control interval I₂ and in the third control interval I₃, i.e. the second inducting heater 4, is energized. For this purpose, the control unit 13 operates the second power switch 18 at a fourth switching frequency f_{SW4}.

In a fifth control interval I₅, having a fifth duration T₅, the control unit 15 activates only the induction heater that had been already activated during the fourth control interval I₄, i.e. the second induction heater 4, by operating the second power switch 18 with a fifth switching frequency f_{SW5}. The fifth switching frequency f_{SW5} is different from and preferably greater than the fourth switching frequency f_{SW4}.

During each of the control intervals I₁-I₅, the control unit 15 measures respective values of delivered power on the basis of the power sense signals S_{SV}, S_{SC1}, S_{SC2} continuously received from the power detector 20. In particular, the control unit 14 uses the values of overall delivered power measured in control intervals I₂-I₅ to determine a first power characteristic PC₁ of the first inductive heater 3 with the cooking vessels 10 coupled thereto and a second power characteristic PC₂ of the second inductive heater 4 with the cooking vessels 10 coupled thereto, as illustrated in FIG. 4 (here, the power characteristic are represented as switching period τ_{SW} vs. delivered power P, where τ_{SW}=1/f_{SW}, obviously). The power characteristics PC₁, PC₂ may be determined e.g. by linear interpolation, due to the fact that each of the inductive heaters 3, 4 is individually energized at two different switching frequencies during control intervals I₂-I₅. Other methods of interpolation may be used as well, in accordance with design preferences. More precisely, the first inductive heater 3 is operated (alone, with the second inductive heater 4 inactive) at the second switching frequency f_{SW2} in the second control interval I₂ and at the third switching frequency f_{SW3} in the third control interval I₃. The control units acquires and stores two power measures P₁(f_{SW2}), P₁ (f_{SW3}) associated with operation of the first inductive heater 3 alone and defines two reference characteristic points (τ_{SW2}; P₁ (f_{SW2})), (τ_{SW3}; P₁ (f_{SW3})).

Likewise, the second inductive heater 4 is operated (alone, with the first inductive heater 3 inactive) at the fourth switching frequency f_{SW4} in the fourth control interval I₄ and at the fifth switching frequency f_{SW5} in the fifth control interval I₅. The control units acquires and stores two power measures P₂ (f_{SW4}), P₂ (f_{SW5}) associated with operation of the second inductive heater 4 alone and defines two reference characteristic points (τ_{SW4}; P₂ (f_{SW4})), (τ_{SW5}; P₂ (f_{SW5})). Advantageously, the third switching frequency f_{SW3} and the fifth control interval I₅ are selected as far away as allowed by operative limits of the power switches 17, 18 from the second switching frequency f_{SW2} and from the fourth switching frequency f_{SW4}, respectively. Thus, the power characteristics PC₁, PC₂ may be continuously updated at every control period I₀ without discontinuities in delivering power to the cooking vessels.

As a general rule, most of the required power for the control period I₀ is delivered in the first control interval I₁, in which both the inductive heaters 3, 4 are energized through the respective power switches 17, 18, and in the second control interval I₂, in which only the inductive heater 3, 4 expected to deliver the highest power is energized (in the example of FIG. 3, the first inductive heater 3 through the first power switch 17). The durations of the first control interval I₁ and of the second control interval I₂ and the first switching frequency f_{SW1} and second switching frequency f_{SW2} are selected to approximate overall power delivery requirements.

The remaining control intervals I₂-I₅ should be selected as short as possible, yet long enough to accurately and consistently determine measurements of overall delivered power. The switching frequencies f_{SW3}-f_{SW5} are selected to complete the power delivery tasks of the induction heaters 3, 4.

More specifically, the parameters to meet user's request of power delivery may be determined based on the following procedure.

A first power target P₁′ for the first induction heater 3 and a second power target P₂′ for the second induction heater 4 are set by a user and indicate the average power to be delivered over each control period I₀.

The first power target P₁′ for the first induction heater 3 and the second power target P₂′ are related to the durations T₁-T₅ and to the switching frequencies f_{SW1}-f_{SW5} as follows

P₁′=(P₁(f_{SW1})T₁+P₁(f_{SW2})T₂+P₁(f_{SW3})T₃)/T (1)

P₂′=(P₂(f_{SW1})T₁+P₂(f_{SW4})T₄+P₂(f_{SW5})T₅)/T (2)

with the constraint

T=T₁+T₂+T₃+T₄+T₅ (3)

Additional constraints allow to determine the durations T₁-T₅ and the switching frequencies f_{SW1}-f_{SW5}.

First, the durations T₃-T₅ are selected to be as short as possible, provided that accurate measurement of the delivered power can be carried out. For example, the durations T₃-T₅ may be from one up to 16 mains half-cycles and are all equal in one embodiment, e.g. 20 ms, corresponding to 2 mains half cycles in a 50 Hz mains line.

Then, in order to cope with symmetry requirements on mains current drained by household appliances, the control period I₀ may be set to an odd number of half-cycles of the AC supply voltage V_{AC} received from the voltage supply line 7. The current symmetry is thus re-established every two control cycle durations in the worst case. Moreover, the control period I₀ is selected to be smaller than a thermal time constant of the cooking vessels 10, 11, whereby power delivery is smooth. In one embodiment, the control period I₀ may be 2010 ms.

The third switching frequency f_{SW3} (higher than the second switching frequency f_{SW2}) and fifth third switching frequency f_{SW5} (higher than the fourth switching frequency f_{SW4}) are selected in a respective upper operative frequency ranges, which are delimited by respective lower limit frequencies and by respective upper operative limits. The upper operative limits define the highest switching frequencies at which the power switches 17, 18 may be safely and correctly operated.

In the upper operative frequency ranges, minimum power is delivered to the inductive heaters 3, 4 through the power switches 17, 18.

The fourth switching frequency f_{SW4} is selected in a lower operative frequency range, which is delimited by an upper limit frequency, lower than the lower limit frequency of the upper operative frequency range of the second inductive heater 4, and by a lower operative limit. The lower operative limit defines the lowest switching frequency at which the power switches 17, 18 may be safely operated, without incurring in failure e.g. because of switch voltage breakdown or thermal runaway. In the lower operative frequency range, maximum power is delivered to the inductive heaters 3, 4 through the power switches 17, 18.

Solutions for the remaining parameters (first duration T₁, first switching frequency f_{SW1}, second switching frequency f_{SW2}; the second duration T₂ is immediately determined from equation (3) once a value for the first duration T₁ has been selected) may be determined with a view of optimizing operation of the induction cooktop 1 in other aspects, e.g. flickering, power loss, component stress and the like. For example, as the first duration T₁ and the second duration T₂ are bound by equation (3) once the third duration T₃, the fourth duration T₄ and the fifth duration T₅ have been set. A pair of values of the first switching frequency f_{SW1} and of the second switching frequency f_{SW2} that best fits an optimization criteria (e.g. minimization of flickering) is selected and the corresponding first duration T₁ is determined. The second duration T₂ is determined from equation (3).

The above procedure is carried out at least when both the induction heaters 3, 4 are in use and a power target is above a programmed minimum power threshold. The power target is set by the user through the user interface 9 and possibly adjusted based on the actual coupling of the vessels 10, 11 with the respective induction heaters 3, 4. When the power target is below the minimum power threshold, normally relatively low, a different control procedure may be used. For example, in the first control interval I₁ only one or none of the induction heaters 3, 4 may be activated and the programmed first duration T₁ and delivered power may be determined from stored rated data. However, any suitable control procedure may be used.

Selection of parameters may be carried out quickly and the selected parameters are readily available. In one embodiment, all the selected parameters are kept constant through subsequent cycles, until power transfer conditions change (e.g. because the user changes cooking settings or a cooking vessel is moved with respect to induction heaters 3, 4) and the power characteristics PC₁, PC₂ are updated.

In another embodiment, the control unit 15 adjusts the switching frequencies f_{SW2}-f_{SW5} in subsequent control periods I₀. Specifically, the third switching frequency f_{SW3} and the fifth switching frequency f_{SW5} are initially set at respective safe values in the upper operative frequency range, relatively far away from the upper operative limit, and then the control unit 15 adjusts the selected values in accordance with actual operating conditions. For example, the third switching frequency f_{SW3} and the fifth switching frequency f_{SW5} may be increased (by decreasing the turn-on time) until the onset of hard-switching conditions or decreased (by increasing the turn-on time) if the voltage on conduction terminals of the power switches 17, 18 is zero at turn-on, thus corresponding to a perfect soft switching condition. In a specular manner, the second switching frequency f_{SW2} and the fourth switching frequency f_{SW4} are initially set at respective safe values in the lower operative frequency range, relatively far away from the lower operative limit, and then the control unit 15 adjusts the selected values in accordance with actual operating conditions. Thereafter, the second switching frequency f_{SW2} and/or the fourth switching frequency f_{SW4} may be decreased if the operative limits of the power switches 17, 18 are sufficiently distant or otherwise increased if the operative limits are being approached. For example, in the quasi resonant converter configuration of FIG. 2, the maximum power the power switches 17, 18 may deliver is limited by the breakdown voltage V_{BD} of the power switches 17, 18 themselves. Considering a derating margin of 10%, the control unit 15 may increase the second switching frequency f_{SW2} and/or the fourth switching frequency f_{SW4} if the measured voltage across the conduction terminals of the active power switches 17, 18 becomes greater than 0.9*V_{BD}. On the other hand, if the measured voltage across the conduction terminals of the active power switches 17, 18 goes below 0.9*V_{BD}, the control unit 15 may decrease the second switching frequency f_{SW2} and/or the fourth switching frequency f_{SW4}.

The adjustment of the switching frequencies f_{SW2}-f_{SW5} may be carried out either during control intervals I₂-I₅ of each control period I₀ or between subsequent control periods I₀.

The induction cooktop and the method described above has several advantages. Besides avoiding audible noise, because the inductive heaters are never simultaneously energized with different switching frequencies, the cooktop is operated in conditions that allow to define power characteristics at every control period without discontinuing power supply to cooking vessels coupled to the inductive heaters. In fact, in each control cycle both the inductive heaters are separately and individually operated with two respective different frequencies in distinct control intervals. This allows to determine the power characteristics of the converter by measuring the overall active power in each of the control intervals in which only one of the power switches is activated and by simply interpolating the measured power values. Thus, the power characteristics may be frequently updated, possibly even at every control period, without the need to perform a frequency scan. On the one side, therefore, frequent updates do not affect power delivery and, on the other side, consistency of the power characteristics may be accurately maintained, to the advantage of efficiency and quality of the cooking process.

Although other solutions are available within the scope of the invention, the overall power delivered by the converter may be measured using extremely simple and cheap sensors. Even a single resistor is perfectly fit to fulfil the task of providing continuous monitoring of power delivery and measurement for the purpose of determining the power characteristics.

The quasi resonant configuration of the converter is particularly advantageous. Quasi resonant converters are widely used as high frequency power supply for induction cooktops and proved to be particularly attractive as being structurally simple and inexpensive, because a single solid state power switch (typically an IGBT) and a single resonant capacitor are required for each induction coil. Quasi resonant converters are also very well suited to the above described control because of fairly linear relationship between delivered power and switching period. In fact, interpolation is simple and accurate, which is a favorable property to achieve good and efficient power control.

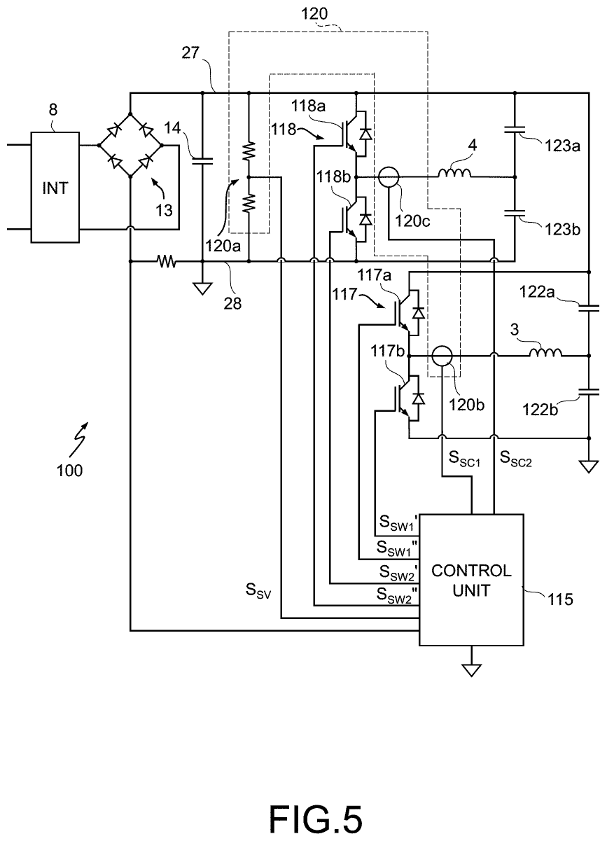

The converter need not be in quasi resonant configuration, however. In the embodiment of FIG. 5, for example, where parts already described are indicated by the same reference numbers, an induction cooktop 100 the first induction heater 3, the second induction heater 4 and a converter 105, configured to couple to the supply line 7 through the coupling interface 8 and to independently energize the induction heaters 3, 4. The converter 105 comprises the rectifier 13, the DC link capacitor 14, a control unit 115, a first switching current generator 117, a second switching current generator 118 and a power detector 120. The first switching current generator 117 and the second switching current generator 118 comprises two first power switches 117a, 117b and the second switching current generator 118 comprises two second power switches 118a, 118b in half-bridge configuration. Specifically, the first induction heater 3 forms a first resonant circuit 125 driven by the first switching current generator 117 with respective first resonant capacitors 122a, 122b and the second induction heater 4 forms a second resonant circuit 126 driven by the second switching current generator 118 with respective second resonant capacitors 123a, 123b.

The power detector 120 comprises a voltage sensing network 120 and current sensors 120b, 120c and supplies power sense signals, based on which the control unit 115 determines the active power delivered by the switching current generators 117, 118. The voltage sensing network 120a may include a voltage divider connected between the rails 27, 28 and having an intermediate node coupled to a voltage sense input of the control unit 115 to provide a voltage sense signal S_{SV}. The current sensors 120b, 120c are configured to sense currents supplied by the switching current generators 117, 118, respectively, and to provide corresponding current sense signals S_{SC1}, S_{SC2} to current sense inputs of the control unit 115. The power sense signals supplied by the power detector 120 include the voltage sense signal S_{SV} and the current sense signals S_{SC1}, S_{SC2}.

The first switching current generator 117 and the second switching current generator 118 are operated by the control unit 115 at the switching frequencies f_{SW1}-f_{SW5} in the control intervals I₁-I₅ of each control period I₀. For this purpose, the control unit 115 supplies first control signals S_{SW1}′, S_{SW1}″ to control terminals of the power switches 117a, 117b of the first switching current generator 117 and second control signals S_{SW2}′, S_{SW2}″ to control terminals of the second switching current generator 118.

Finally, it is clear that modifications and variants can be made to the cooktop and to the method described herein without departing from the scope of the present invention, as defined in the appended claims.

For example, the control period I₀ may contain other control intervals in addition to the control intervals I₁-I₅, in accordance with design preferences. Additional control intervals may be introduced to determine more than two points for the power characteristics and refine interpolation. Moreover, the control intervals I₁-I₅ need not be in the order presented above and any other order may be chosen. In particular, it is emphasized that the wording first, second, third fourth and fifth control interval only reflects the specific example that has been presented and has the sole purpose of distinguishing the control intervals from one another. In no way such language may be interpreted as meaning or implying that the control intervals and the actions carried out in each of the control intervals require any specific order.

1. An induction cooktop comprising:
a first induction heater (3) and a second induction heater (4);
a control unit (15; 115);
a first switching current generator (17; 117) and a second switching current generator (18; 118), operable by the control unit (15) in subsequent control periods (I₀) to energize the first induction heater (3) and the second induction heater (4), respectively;
wherein the control unit (15; 115) is configured to:
at least when a power target to be delivered is above a programmed minimum power threshold, operate both the first switching current generator (17; 117) and the second switching current generator (18) with a first switching frequency (f_{SW1}) in a first control interval (T₁) of each control period (I₀);
operate only the first switching current generator (17; 117) with at least two respective different switching frequencies (f_{SW2}, f_{SW3}) in a second control interval (I₂) and in a third control interval (I₃) of each control period (I₀), while the second switching current generator (18; 118) is inactive;
operate only the second switching current generator (18; 118) with at least two respective different switching frequencies (f_{SW4}, f_{SW5}) in a fourth control interval (I₄) and in a fifth control interval (I₅) of each control period (I₀), while the first switching current generator (17; 117) is inactive.

2. The induction cooktop according to claim 1, comprising a power detector (20; 120) configured to sense an active power delivered by the first induction heater (3) and by the second induction heater (4), wherein the control unit (15; 115) is further configured to determine a first power characteristic (PC₁) of the first inductive heater (3) and a second power characteristic (PC₂) of the second inductive heater (4) based on power sense signals (S_{SV}, S_{SC1}, S_{SC2}) received from the power detector (20; 120).

3. The induction cooktop according to claim 2, wherein the control unit is further configured to:
select the third switching frequency (f_{SW5}) and the fifth third switching frequency (f_{SW5}) in respective upper operative frequency ranges, which are delimited by respective upper operative limits for the first induction heater (3) and the second induction heater (4); and
select the fourth switching frequency (f_{SW4}) in a lower operative frequency range, which is delimited by a upper limit frequency, lower than the lower limit frequency of the upper operative frequency range the second induction heater (4), and by a lower operative limit.

4. The induction cooktop according to claim 2, configured to couple to a supply line (7) to receive an AC supply voltage (V_{AC}), wherein the control unit is further configured to select respective durations (T₃, T₄, T₅) of the third control interval (I₃), of the fourth control interval (I₄) and of the fifth control interval (I₅) as up to 16 half-cycles of the AC supply voltage (V_{AC}) and preferably to set the control period (I₀) to an odd number of half-cycles of the AC supply voltage (V_{AC}).

5. The induction cooktop according to claim 2, wherein the control unit (15; 115) is further configured to:
operate only the first switching current generator (17; 117) with a second switching frequency (f_{SW2}) in the second control interval (I₂) and with a third switching frequency (f_{SW3}) in the third control interval (I₃);
acquire and store first power measures (P₁ (f_{SW2}), P₁ (f_{SW3})) associated with operation of the first inductive heater (3) alone in the second control interval (I₂) and in the third control interval (I₃) from the power sense signals (S_{SV}, S_{SC1}, S_{SC2});
operate only the second switching current generator (18; 118) with a fourth switching frequency (f_{SW4}) in the fourth control interval (I₄) and with a fifth switching frequency (f_{SW5}) in the fifth control interval (I₅); and
acquire and store second power measures (P₂ (f_{SW4}), P₂ (f_{SW5})) associated with operation of the second inductive heater (4) alone in the fourth control interval (I₄) and in the fifth control interval (I₅) from the power sense signals (S_{SV}, S_{SC1}, S_{SC2}).

6. The induction cooktop according to claim 2, wherein the control unit (15; 115) is further configured to:
determine first reference characteristic points (τ_{SW2}; P₁ (f_{SW2})), (τ_{SW3}; P₁(f_{SW3})) from the first power measures (P₁ (f_{SW2}), P₁ (f_{SW3})) and from the second switching frequency (f_{SW2}) and third switching frequency (f_{SW3});
determine second reference characteristic points (τ_{SW4}; P₂(f_{SW4})), (τ_{SW5}; P₂ (f_{SW5})) from the second power measures (P₂ (f_{SW4}), P₂ (f_{SW5})) and from the fourth switching frequency (f_{SW4}) and fifth switching frequency (f_{SW5}); and
determine the first power characteristic (PC₁) and the second power characteristic (PC₂) by interpolating the first reference characteristic points (τ_{SW2}; P₁(f_{SW2})), (τ_{SW3}; P₁ (f_{SW3})) and the second reference characteristic points (τ_{SW4}; P₂ (f_{SW4})), (τ_{SW5}; P₂ (f_{SW5})).

7. The induction cooktop according to claim 5, wherein the control unit (15; 115) is further configured to determine at least a first duration (T₁) of the first control interval (I₁), the first switching frequency (f_{SW1}) and the second switching frequency (f_{SW2}) from the following equations:
P₁′=(P₁(f_{SW1})T₁+P₁(f_{SW2})T₂+P₁(f_{SW3})T₃)/T
P₂′=(P₂(f_{SW1})T₁+P₂(f_{SW4})T₄+P₂(f_{SW5})T₅)/T
wherein P₁′ and P₂′ are a first power target and a second power target for the first induction heater (3) and the second induction heater (4), respectively, P₁ (f_{SW1}), P₁ (f_{SW2}) and P₁ (f_{SW3}) indicate power delivered by the first induction heater (3) when operated at the first switching frequency (f_{SW1}), at the second switching frequency (f_{SW2}) and at the third switching frequency (f_{SW3}), respectively, P₂ (f_{SW1}), P₂(f_{SW4}) and P₂ (f_{SW5}) indicate power delivered by the second induction heater (4) when operated at the first switching frequency (f_{SW1}), at the fourth switching frequency (f_{SW4}) and at the fifth switching frequency (f_{SW5}), respectively, T₁-T₅ are the respective durations of the first to fifth control intervals (I₁-I₅) and T is a duration of the control period (I₀).

8. A method of controlling an induction cooktop comprising a first induction heater (3), a second induction heater (4), a first switching current generator (17) and a second switching current generator (18; 118), the first switching current generator (17; 117) and a second switching current generator (18; 118) being operable in subsequent control periods (I₀) to energize the first induction heater (3) and the second induction heater (4), respectively;
the method comprising:
operating both the first switching current generator (17; 117) and the second switching current generator (18; 118) with a first switching frequency (f_{SW1}) in a first control interval (I₁) of each control period (I₀);
at least when a power target to be delivered is above a programmed minimum power threshold, operating only the first switching current generator (17; 117) with at least two respective different switching frequencies (f_{SW2}, f_{SW3}) in a second control interval (I₂) and in a third control interval (I₃) of each control period (I₀), while the second switching current generator (18; 118) is inactive;
operating only the second switching current generator (18; 118) with at least two respective different switching frequencies (f_{SW4}, f_{SW3}) in a fourth control interval (I₄) and in a fifth control interval (I₅) of each control period (I₀), while the first switching current generator (17; 117) is inactive.

9. The method according to claim 8, comprising:
sensing an active power delivered by the first induction heater (3) and by the second induction heater (4); and
determining a first power characteristic (PC₁) of the first inductive heater (3) and a second power characteristic (PC₂) of the second inductive heater (4) based on sensed active power.

10. The method according to claim 9, comprising:
selecting the third switching frequency (f_{SW3}) and the fifth third switching frequency (f_{SW5}) in respective upper operative frequency ranges, which are delimited by respective lower limit frequencies and by respective upper operative limits for the first induction heater (3) and the second induction heater (4); and
selecting the fourth switching frequency (f_{SW4}) in a lower operative frequency range, which is delimited by a upper limit frequency, lower than the respective lower limit frequency for the second induction heater (4), and by a lower operative limit.

11. The method according to claim 10, comprising:
initially setting the third switching frequency (f_{SW3}) and the fifth switching frequency (f_{SW5}) at respective safe values in the upper operative frequency range, and then adjusting the selected values of the third switching frequency (f_{SW3}) and of the fifth switching frequency (f_{SW5}); and
initially setting the second switching frequency (f_{SW2}) and the fourth switching frequency (f_{SW4}) at respective safe values in the lower operative frequency range, and then adjusting the selected values of the second switching frequency (f_{SW2}) and of the fourth switching frequency (f_{SW4}).

12. The method according to claim 9, comprising receiving an AC supply voltage (V_{AC}) and selecting respective durations (T₃, T₄, T₅) of the third control interval (I₃), of the fourth control interval (I₄) and of the fifth control interval (I₅) as up to 16 half-cycles of the AC supply voltage (V_{A}c) and preferably setting the control period (I₀) to an odd number of half-cycles of the AC supply voltage (V_{AC}).

13. The method according to claim 9, wherein:
operating only the first switching current generator (17; 117) comprises operating the first switching current generator (17; 117) with a second switching frequency (f_{SW2}) in the second control interval (I₂) and with a third switching frequency (f_{SW3}) in the third control interval (I₃);
operating only the second switching current generator (18; 118) comprises operating the second switching current generator (18; 118) with a fourth switching frequency (f_{SW4}) in the fourth control interval (I₄) and with a fifth switching frequency (f_{SW5}) in the fifth control interval (I₅); and
determining the first power characteristic (PC₁) and the second power characteristic (PC₂) comprises acquiring and storing first power measures (P₁ (f_{SW2}), P₁ (f_{SW3})) associated with operation of the first inductive heater (3) alone in the second control interval (I₂) and in the third control interval (I₃) and acquiring and storing second power measures (P₂ (f_{SW4}), P₂ (f_{SW5})) associated with operation of the second inductive heater (4) alone in the fourth control interval (I₄) and in the fifth control interval (I₅) from the sensed active power.

14. The method according to claim 13, wherein
determining the first power characteristic (PC₁) and the second power characteristic (PC₂) comprises:
determining first reference characteristic points (τ_{SW2}; P₁ (f_{SW2})), (τ_{SW3}; P₁(f_{SW3})) from the first power measures (P₁ (f_{SW2}), P₁ (f_{SW3})) and from the second switching frequency (f_{SW2}) and third switching frequency (f_{SW3});
determining second reference characteristic points (τ_{SW4}; P₂(f_{SW4})), (τ_{SW5}; P₂ (f_{SW5})) from the second power measures (P₂ (f_{SW4}), P₂ (f_{SW5})) and from the fourth switching frequency (f_{SW4}) and fifth switching frequency (f_{SW5}); and
interpolating the first reference characteristic points (τ_{SW2}; P₁ (f_{SW2})), (τ_{SW3}; P₁ (f_{SW3})) and the second reference characteristic points (τ_{SW4}; P₂ (f_{SW4})), (τ_{SW5}; P₂(f_{SW5})).

15. The method according to claim 13, comprising determining at least a first duration (T₁) of the first control interval (I₁), the first switching frequency (f_{SW1}) and the second switching frequency (f_{SW2}) from the following equations:
P₁′=(P₁(f_{SW1})T₁+P₁(f_{SW2})T₂+P₁(f_{SW3})T₃)/T
P₂′=(P₂(f_{SW1})T₁+P₂(f_{SW4})T₄+P₂(f_{SW5})T₅)/T
wherein P₁′ and P₂′ are a first power target and a second power target for the first induction heater (3) and the second induction heater (4), respectively, P₁ (f_{SW1}), P₁ (f_{SW2}) and P₁ (f_{SW3}) indicate power delivered by the first induction heater (3) when operated at the first switching frequency (f_{SW1}), at the second switching frequency (f_{SW2}) and at the third switching frequency (f_{SW3}), respectively, P₂ (f_{SW1}), P₂(f_{SW4}) and P₂ (f_{SW5}) indicate power delivered by the second induction heater (4) when operated at the first switching frequency (f_{SW1}), at the fourth switching frequency (f_{SW4}) and at the fifth switching frequency (f_{SW5}), respectively, T₁-T₅ are the respective durations of the first to fifth control intervals (I₁-I₅) and T is a duration of the control period (I₀).
